(19) United States
(12) Patent Application Publication
(10) Pub. No.: US 2025/0325909 A1
(43) Pub. Date: Oct. 23, 2025

(54) On-Line Word Puzzle

(71) Applicant: Caleb John Severn, Stevenage (GB)

(72) Inventor: Caleb John Severn, Stevenage (GB)

(21) Appl. No.: 19/169,754

(22) Filed: Apr. 3, 2025

Related U.S. Application Data
(60) Provisional application No. 63/631,050, filed on Apr. 8, 2024.

(51) Int. Cl. A63F 13/533; A63F 13/5375; A63F 13/80

(52) U.S. Cl. CPC A63F 13/533; A63F 13/5375; A63F 13/80

(57) ABSTRACT

A computer implemented on-line word puzzle game system, adapted to present to a player the on-line word puzzle game to be played by the player. A grid comprising a plurality of rows and columns of blank defined spaces is displayed. There is a keyboard display with letters of an alphabet, wherein the letters are configured to be selected with a computer input device, and a display of an initial quantity of play tokens. There is a letter hint comprising the selection, for use by the player, of less than all letters of the keyboard. A user input includes a choice by the player of a keyboard letter for a particular blank space of the displayed grid. Display icons indicate if a letter selected for a particular blank space is correct, is wrong, is in the correct column, or is in the correct row. A token counter is configured to count the quantity of play tokens down by one each time an incorrect selection is made. The puzzle is solved if all of the blank spaces are filled in with the correct letters before the token counter reaches zero.

### CROSS-REFERENCE TO RELATED APPLICATION

This application claims priority of Provisional Patent Application 63/631,050, filed on Apr. 8, 2024. The disclosure of this priority application is incorporated by reference herein in its entirety, and for all purposes.

### BACKGROUND OF THE INVENTION

On-line word games are extremely popular.

### SUMMARY OF THE INVENTION

In one aspect a computer implemented on-line word puzzle game system, adapted to present to a player the on-line word puzzle game to be played by the player, includes a displayed grid comprising a plurality of rows and columns of blank defined spaces, a keyboard display with letters of an alphabet, wherein the letters are configured to be selected with a computer input device, a display of an initial quantity of play tokens, a letter hint comprising the selection, for use by the player, of less than all letters of the keyboard, an input comprising a choice by the player of a keyboard letter for a particular blank space of the displayed grid, display icons that indicate if a letter selected for a particular blank space is correct, is wrong, is in the correct column, or is in the correct row, and a token counter that is configured to count the quantity of play tokens down by one each time an incorrect selection is made. The puzzle is solved and indicated as such to the player if all of the blank spaces are filled in with the correct letters before the token counter reaches zero.

In an example the token counter is configured to add one token when a correct selection is made. In an example the maximum quantity of tokens in the token counter is limited to the initial quantity. In an example a display icon comprises an arrow. In an example the arrow is one or both of horizontal and vertical. In an example a display icon comprises a color. In an example the grid is square. In an example the grid includes sixteen square spaces arranged in four rows and four columns.

In an example the letter hint comprises some of the letters of the keyboard display disabled from being selected. In an example the letters of the keyboard display disabled from being selected are indicated by coloring the locations of the disabled letters black. In an example the letters of the keyboard display disabled from being selected are indicated by removing the disabled letters from the keyboard display.

In another aspect a computer implemented method for controlling a display of a computer device adapted to play a computer game by a player, the device including at least one processor, at least one memory, and a user interface, the method comprising executing on the at least one processor the steps of displaying a grid comprising a plurality of rows and columns of blank defined spaces, displaying a keyboard with letters of an alphabet, wherein the letters are configured to be selected with a computer input device, displaying of an initial quantity of play tokens, providing a letter hint comprising the selection, for use by the player, of less than all letters of the keyboard, accepting a player input comprising a choice by the player of a keyboard letter for a particular blank space of the displayed grid, displaying icons that indicate if a letter selected for a particular blank space is correct, is wrong, is in the correct column, or is in the correct row, and displaying a token counter, wherein the at least one processor is configured to count the quantity of play tokens down by one each time an incorrect selection is made. The puzzle is solved and displayed to the player if all of the blank spaces are filled in with the correct letters before the token counter reaches zero.

In another aspect a non-transitory computer readable medium encoded with instructions which, when executed by at least one processor of a computer device adapted to play a computer game by a player, perform a method for controlling a display of the computer device, the method comprising controlling the display to display a grid comprising a plurality of rows and columns of blank defined spaces, controlling the display to display a keyboard with letters of an alphabet, wherein the letters are configured to be selected with a computer input device, controlling the display to display an initial quantity of play tokens, controlling the display to provide a letter hint comprising the selection, for use by the player, of less than all letters of the keyboard, receiving player input via a user interface of the computer device, the user input comprising a choice by the player of a keyboard letter for a particular blank space of the displayed grid, controlling the display to display icons that indicate if a letter selected for a particular blank space is correct, is wrong, is in the correct column, or is in the correct row, and controlling the display to display a token counter, wherein the at least one processor is configured to count the quantity of play tokens down by one each time an incorrect selection is made. The puzzle is solved and displayed to the player if all of the blank spaces are filled in with the correct letters before the token counter reaches zero.

### BRIEF DESCRIPTION OF DRAWINGS

FIG. 1 is an exemplary landing page display.

FIG. 2 is an example of a display when a letter square is selected.

FIG. 3 is an example of a display of the letters and words when the game has been won.

FIG. 4 is an example of a display of the order of the letters when the game has been won.

FIG. 5 is an example of a display of the correct letters and words when the game has been lost.

FIG. 6 is a schematic diagram of an internet-based computer system that is configured to allow a player to play the game.

### DETAILED DESCRIPTION OF THE INVENTION

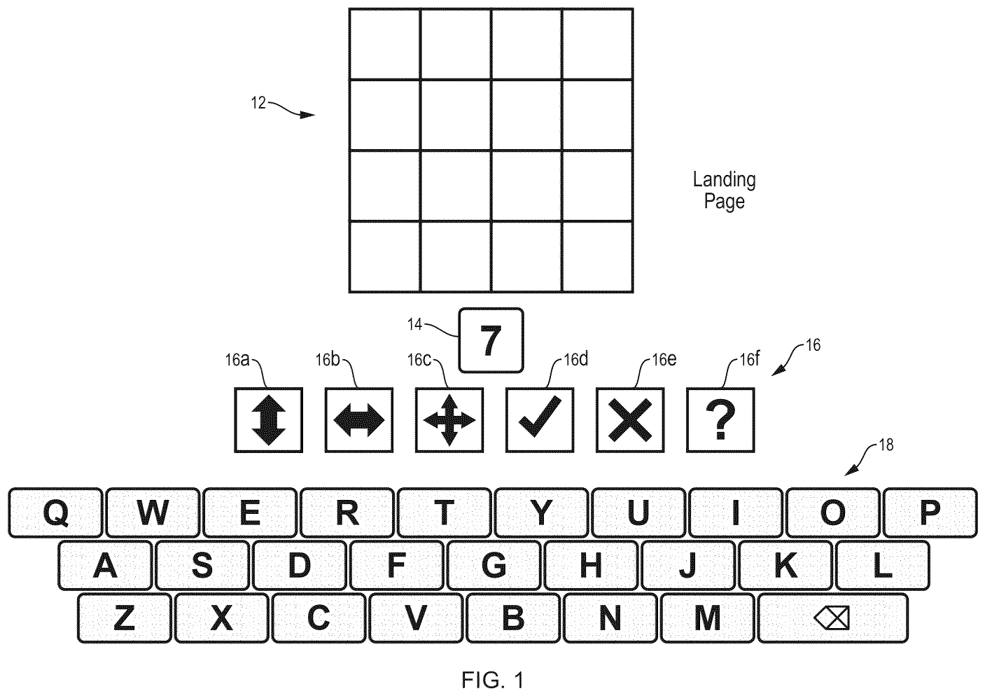

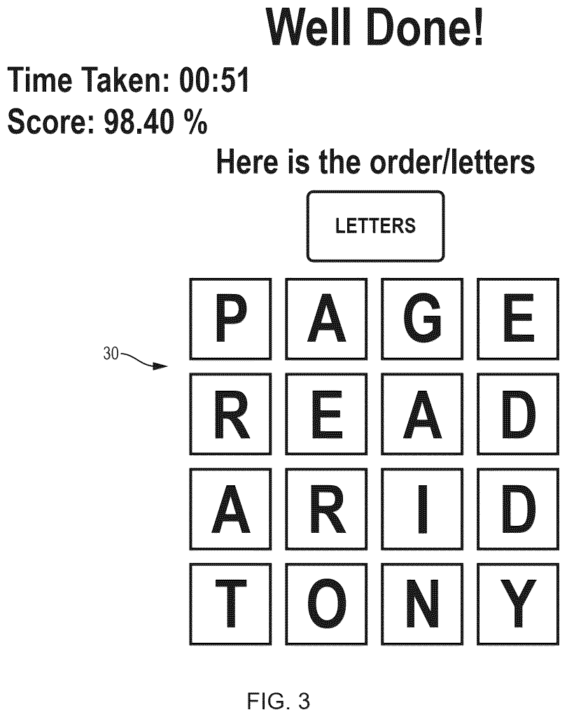

Featured in this disclosure is an on-line word puzzle. The puzzle includes a grid of blank defined spaces (e.g., squares) arranged in rows and columns. In an example there are sixteen squares arranged in a four-by-four grid, with four rows of four squares each and four columns of four squares each, as shown in the blank puzzle shown in the “Landing Page”, FIG. 1 of the drawings. Other sizes (numbers of rows and columns) and grid shapes are possible. The solution to the puzzle is the correct letter in each blank square, in this non-limiting example making up eight (four letter) words, one in each row and one in each column. Thus, each letter is a letter of two four-letter words. A puzzle solution is also shown in FIG. 3 of the drawings.

The puzzle is played as follows. The puzzle can be a daily puzzle where a word square of rows and columns. Are made up of words. The aim of the game is to get the words before you lose all your tokens. Click on a square and the keyboard will give you clues, enter a letter and the square will change color. Every time you enter a letter that is incorrect (even if you get a hint) you lose one token. Black filled letters are not a possibility. Grey filled letters (and/or a question mark) are a possibility to use in the square. A blue background (and/or a vertical double headed arrow) means that this letter is somewhere else in this column, and one token is lost. An orange background (and/or a horizontal double headed arrow) means that this letter is somewhere else in this row, and one token is lost. A split color background (and/or a vertical and horizontal double headed arrow) means that this letter is somewhere else in this row and in this column, and one token is lost. A green background (and/or a check mark) means that this letter is in the correct position, and one token is earned back (i.e., added to the token counter).

The screen, an example of which is shown in FIG. 1, includes the blank grid 12 and a qwerty keyboard 18, the keys of which can be selected with a computer input device such as a mouse, touchpad or touch, for example, depending upon the device being used (e.g., smartphone or laptop or desktop computer). The alphanumeric characters of the keyboard can be selected to match any language. The screen also displays a quantity of “tokens” available/remaining, space 14 indicating seven tokens to start. A quantity of tokens is assigned at the beginning of the puzzle game, based on the number of unique letters in the puzzle; more tokens are provided for puzzles that have more unique letters. The object of the puzzle is to correctly fill in all sixteen letters before running out of tokens. Puzzle play will be described in more detail below.

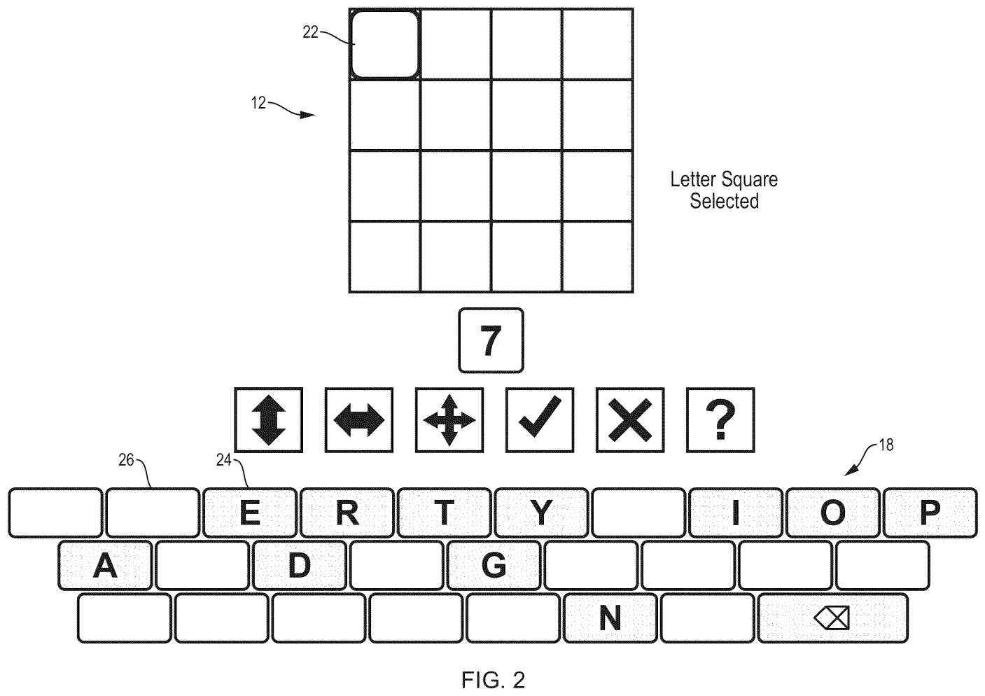

The initial screen also includes six icons 16 that are related to puzzle play and hints. The black-filled square, potentially with an “X,” (16e) tells the user that when keys on the keyboard turn black, they are not used in the puzzle. Grey letters (16f) are letters that might be used in the puzzle. Thus, the grey letters are a hint to the solution. FIG. 2 is a depiction of the keyboard 18 with possible letters shown (e.g., letter 24) and blacked-out, not possible letters shown as blanks, such as blank 26 which would be the letter “W.” A blue or teal color to a square with a vertical double-ended arrow (16a) indicates that a selected letter is located elsewhere in the column rather than in the selected square. Note that the colors are not included in the drawings but can be used in the actual puzzle game. An orange color to a square with a horizontal double-ended arrow (16b) indicates that a selected letter is located elsewhere in the row rather than in the selected square. A half blue/half orange color to a square with both horizontal and vertical double-ended arrows (16c) indicates that a selected letter is located elsewhere in the row and elsewhere in the column. A green color with a checkmark (16d) indicates a correct letter selection. Note that either one or both of the color and the graphic (arrow(s), check mark, X, question mark) can be used. Other indicators, not shown, could be used.

Puzzle play proceeds as follows. At the start and with the cursor not located in the grid, all the letters on the keyboard are visible. When any square is clicked on the square turns white and all available (i.e., possible) letters of the keyboard are grey, with the rest of the letters (that are not possible) in black. The game timer begins when the first square is selected. See FIG. 2, where square 22 was selected and turns white. Thus, only a grey letter can be selected for the current square. The grey letters are thus a hint. When a letter is selected for the current square (by clicking on it or equivalent), if it is correct a green color and/or checkmark is displayed, and one token is added (except that the number of tokens can never exceed the initial quantity of tokens). The green can persist for a short time, or until another square is selected. The correct letter will remain in the square. If the selected letter is properly located elsewhere in the row and/or column of the selected square, the blue or orange or blue/orange color and/or the arrow icon is displayed in the square, as appropriate. Since this is an incorrect selection, one token is deducted. If the selected letter is wrong and is not in the current column or row, the square changes color (e.g., to white), and one token is deducted. Play continues until the puzzle is solved (a win) or all tokens are gone (a loss). The system keeps track of the amount of play time and the solution. See FIG. 3. This information can be stored locally, in part to alleviate user privacy concerns that accompany the remote storage of data, or it can be stored remotely, or both. Scoring is based on wins and losses, the number of mistakes made, and the time it took to correctly solve the puzzle.

In one non-limiting example the game uses primarily a calculation based on maximum number of possible errors. Scoring is determined as follows: score=log₁₀(start tokens+14−mistakes made)/log₁₀(start tokens+14). This is to calculate how many possible mistakes you can make. Technically you can make 15 mistakes due to the 16 squares, from the first key press (on the 16th mistake you will lose) plus the number of tokens you start with. Then it is log distributed so that you get a better distribution of numbers where it rewards you more for fewer mistakes and punishes you harder for more mistakes. The methodology of (logarithmic) calculation might change.

For example, in a game where you have seven tokens if you managed to win only making three mistakes, you'd get a score of 95% with log distribution, without the log distribution you would get 86%. Starting tokens can be variable based on the difficulty of the game. This scoring algorithm will thus push the players into trying to be better. But it also means you can technically get 0% if you have one mistake left, and it also rounds it down if you have two mistakes left. This is to try and discourage players going for pure time at the cost of losing all their tokens. Nobody wants to share a score that says, “You got 0% but hey you were really fast”. The log distribution may change in future, but the scoring will always be based on starting tokens and possible mistakes made.

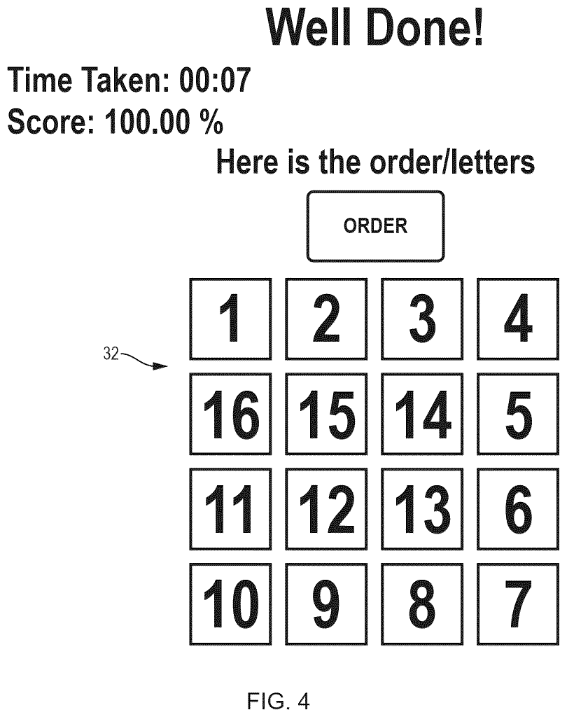

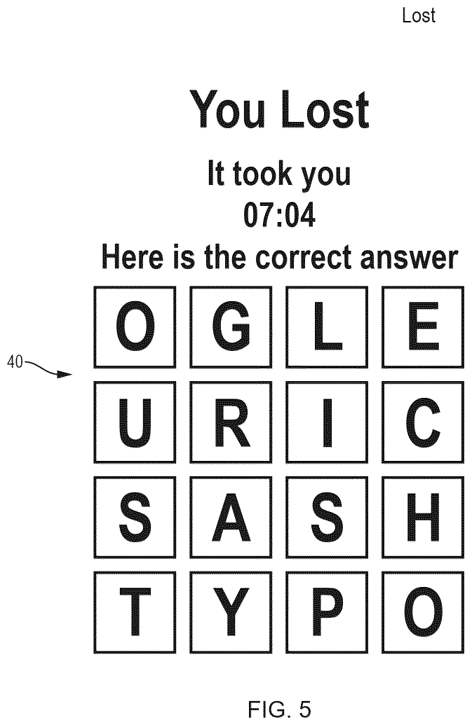

After a correct solution the time is displayed and a link or icon can be clicked to display the order in which the correct letters were selected (FIG. 4), which can help the player learn how their play may be improved. After a loss the solution is displayed along with the amount of elapsed time, FIG. 5.

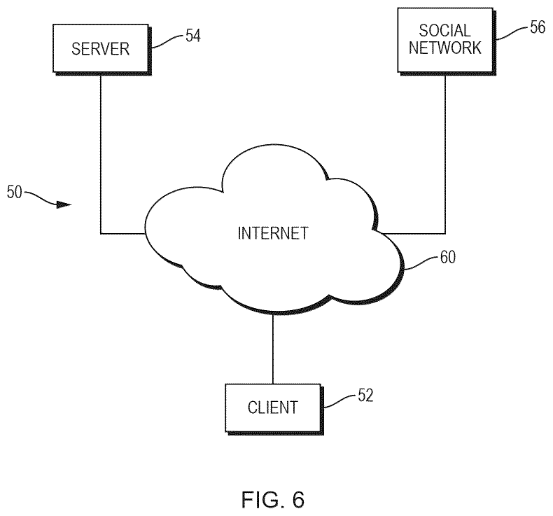

FIG. 6 is a schematic diagram of an internet-based computer system 50 that is configured to allow a player to play the game. Client computer device 52 is used to play the game. It can be, for example, a smart phone, a tablet, a laptop or a desktop computer, with at least one processor, at least one memory, and a user interface. Device 52 implements the game playing methods. It can communicate (e.g., via internet 60) with a server 54 that can provide the instructions that are implemented by device 52 to allow game play. Social network 56 can also be in communication with device 52, for example to allow the player to share the game and game playing results with others who have access to social network 56.

Having described above several aspects of at least one example, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

1. A computer implemented on-line word puzzle game system, adapted to present to a player the on-line word puzzle game to be played by the player, comprising:
a displayed grid comprising a plurality of rows and columns of blank defined spaces;
a keyboard display with letters of an alphabet, wherein the letters are configured to be selected with a computer input device;
a display of an initial quantity of play tokens;
a letter hint comprising the selection, for use by the player, of less than all letters of the keyboard;
an input comprising a choice by the player of a keyboard letter for a particular blank space of the displayed grid;
display icons that indicate if a letter selected for a particular blank space is correct, is wrong, is in the correct column, or is in the correct row; and
a token counter that is configured to count the quantity of play tokens down by one each time an incorrect selection is made;
wherein the puzzle is solved and indicated as such to the player if all of the blank spaces are filled in with the correct letters before the token counter reaches zero.

2. The on-line word puzzle game system method of claim 1, wherein the token counter is configured to add one token when a correct selection is made.

3. The on-line word game system of claim 2, wherein the maximum quantity of tokens in the token counter is limited to the initial quantity.

4. The on-line word puzzle game system of claim 1, wherein a display icon comprises an arrow.

5. The on-line word puzzle game system of claim 4, wherein the arrow is one or both of horizontal and vertical.

6. The on-line word puzzle game system of claim 1, wherein a display icon comprises a color.

7. The on-line word puzzle game system of claim 1, wherein the grid is square.

8. The on-line word puzzle game system of claim 7, wherein the grid includes sixteen square spaces arranged in four rows and four columns.

9. The on-line word puzzle game system of claim 1, wherein the letter hint comprises some of the letters of the keyboard display disabled from being selected.

10. The on-line word puzzle game system of claim 9, wherein the letters of the keyboard display disabled from being selected are indicated by coloring the locations of the disabled letters black.

11. The on-line word puzzle game system of claim 9, wherein the letters of the keyboard display disabled from being selected are indicated by removing the disabled letters from the keyboard display.

12. A computer implemented method for controlling a display of a computer device adapted to play a computer game by a player, the device including at least one processor, at least one memory, and a user interface, the method comprising executing on the at least one processor the steps of:
displaying a grid comprising a plurality of rows and columns of blank defined spaces;
displaying a keyboard with letters of an alphabet, wherein the letters are configured to be selected with a computer input device;
displaying of an initial quantity of play tokens;
providing a letter hint comprising the selection, for use by the player, of less than all letters of the keyboard;
accepting a player input comprising a choice by the player of a keyboard letter for a particular blank space of the displayed grid;
displaying icons that indicate if a letter selected for a particular blank space is correct, is wrong, is in the correct column, or is in the correct row; and
displaying a token counter, wherein the at least one processor is configured to count the quantity of play tokens down by one each time an incorrect selection is made;
wherein the puzzle is solved and displayed to the player if all of the blank spaces are filled in with the correct letters before the token counter reaches zero.

13. A non-transitory computer readable medium encoded with instructions which, when executed by at least one processor of a computer device adapted to play a computer game by a player, perform a method for controlling a display of the computer device, the method comprising:
controlling the display to display a grid comprising a plurality of rows and columns of blank defined spaces;
controlling the display to display a keyboard with letters of an alphabet, wherein the letters are configured to be selected with a computer input device;
controlling the display to display an initial quantity of play tokens;
controlling the display to provide a letter hint comprising the selection, for use by the player, of less than all letters of the keyboard;
receiving player input via a user interface of the computer device, the user input comprising a choice by the player of a keyboard letter for a particular blank space of the displayed grid;
controlling the display to display icons that indicate if a letter selected for a particular blank space is correct, is wrong, is in the correct column, or is in the correct row; and
controlling the display to display a token counter, wherein the at least one processor is configured to count the quantity of play tokens down by one each time an incorrect selection is made;
wherein the puzzle is solved and displayed to the player if all of the blank spaces are filled in with the correct letters before the token counter reaches zero.
